(19) United States
(12) Patent Application Publication
(10) Pub. No.: US 2012/0055149 A1
(43) Pub. Date: Mar. 8, 2012

(54) SEMI-CLOSED HYDRAULIC SYSTEMS

(75) Inventor: Mark Phillip Vonderwell, Franklin, WI (US)

(73) Assignee: Bucyrus International, Inc.

(21) Appl. No.: 12/874,858

(22) Filed: Sep. 2, 2010

(51) Int. Cl. F16D 31/02

(52) U.S. Cl. 60/486

(57) ABSTRACT

A semi-closed hydraulic system for use with heavy equipment includes a double-acting cylinder, a reservoir, first and second electric motors, first and second electric pumps, a pressure sensor, and a controller. The double-acting cylinder has a rod end and a cap end, and the reservoir is designed to provide hydraulic fluid to and receive hydraulic fluid from the cap end of the double-acting cylinder. The first pump is connected to and designed to be driven by the first electric motor. Furthermore, the first pump is bi-directional and is intermediate to the rod end and the cap end of the double-acting cylinder, such that the first pump is designed to provide hydraulic fluid to the rod end from the cap end, and to the cap end from the rod end. In addition, the second pump is coupled to and designed to be driven by the second electric motor, where the second pump is intermediate to the cap end of the double-acting cylinder and the reservoir. The second pump is also bi-directional and designed to provide hydraulic fluid to the cap end from the reservoir, and to the reservoir from the cap end. The pressure sensor provides an output signal related to the pressure of hydraulic fluid of the rod end of the double-acting cylinder, and the controller is connected to the pressure sensor. The controller operates the first pump at least partially as a function of the output signal provided by the pressure sensor during operation of the semi-closed hydraulic system.

### BACKGROUND

The present disclosure relates generally to the field of hydraulic systems including hydraulic cylinders. More specifically the present disclosure relates to semi-closed hydraulic systems for operation of double-acting cylinders to control heavy equipment, particularly for mining, excavating, and such.

### SUMMARY

One embodiment relates to a semi-closed hydraulic system for use with heavy equipment. The system includes a double-acting cylinder, a reservoir, first and second electric motors, first and second electric pumps, a pressure sensor, and a controller. The double-acting cylinder has a rod end and a cap end. The reservoir is designed to provide hydraulic fluid to and receive hydraulic fluid from the cap end of the double-acting cylinder. The first pump is connected to and designed to be driven by the first electric motor. Furthermore, the first pump is bi-directional and is intermediate to the rod end and the cap end of the double-acting cylinder, such that the first pump is designed to provide hydraulic fluid to the rod end from the cap end, and to the cap end from the rod end. In addition, the second pump is coupled to and designed to be driven by the second electric motor, where the second pump is intermediate to the cap end of the double-acting cylinder and the reservoir. The second pump is also bi-directional and designed to provide hydraulic fluid to the cap end from the reservoir, and to the reservoir from the cap end. The pressure sensor provides an output signal related to the pressure of hydraulic fluid of the rod end of the double-acting cylinder, and the controller is connected to the pressure sensor. The controller operates the first pump at least partially as a function of the output signal provided by the pressure sensor during operation of the semi-closed hydraulic system.

Another embodiment relates to a hydraulic system that includes a double-acting cylinder, a reservoir, first and second pumps, and first and second pressure sensors. The double-acting cylinder has a rod end and a cap end, and the reservoir is designed to provide hydraulic fluid to and receive hydraulic fluid from the cap end of the double-acting cylinder. The first pump is bi-directional and is coupled intermediate to the rod end and the cap end of the double-acting cylinder, such that the first pump is designed to provide hydraulic fluid to the rod end from the cap end, and to the cap end from the rod end. In addition, the second pump is bi-directional and is coupled intermediate to the cap end of the double-acting cylinder and the reservoir. The second pump is designed to provide hydraulic fluid to the cap end of the double-acting cylinder from the reservoir, and to alternatively provide hydraulic fluid to the reservoir from the cap end of the double-acting cylinder. The first pressure sensor is in communication with hydraulic fluid of the rod end of the double-acting cylinder, and the first pump is controlled at least partially as a function of an output signal provided by the first pressure sensor during operation of the hydraulic system. The second pressure sensor is in communication with hydraulic fluid of the cap end of the double-acting cylinder, and the second pump is controlled at least partially as a function of an output signal provided by the second pressure sensor during operation of the hydraulic system.

Yet another embodiment relates to a hydraulic system that includes a double-acting cylinder having a rod end and a cap end, and a second cylinder. The system further includes a first pump coupled to and designed to be driven by a first electric motor. The first pump is intermediate to the rod end and the cap end of the double-acting cylinder. Furthermore, the first pump is bi-directional and is designed to provide hydraulic fluid to the rod end from the cap end, and to the cap end from the rod end. In addition, the system includes a second pump coupled to and designed to be driven by a second electric motor. The second pump is intermediate to the cap end of the double-acting cylinder and the second cylinder. The second pump is bi-directional and designed to provide hydraulic fluid to the cap end of the double-acting cylinder from the second cylinder, and to also provide hydraulic fluid to the second cylinder from the cap end of the double-acting cylinder. As such, energy is regenerated between the double-acting cylinder and the second cylinder.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a power shovel according to an exemplary embodiment.

FIG. 2 is a schematic diagram of a hydraulic system according to an exemplary embodiment.

FIG. 3 is a schematic diagram of the hydraulic system of FIG. 2 with additional components according to an exemplary embodiment.

FIG. 4 is a schematic diagram of a hydraulic system according to another exemplary embodiment.

FIG. 5 is a schematic diagram of the hydraulic system of FIG. 4 with additional components according to an exemplary embodiment.

FIG. 6 is a schematic diagram of the hydraulic system of FIG. 4 with additional components according to another exemplary embodiment.

FIG. 7 is a schematic diagram of a hydraulic system for a power shovel according to an exemplary embodiment.

FIG. 8 is a schematic diagram of the hydraulic system of FIG. 7 in a first configuration.

FIG. 9 is a schematic diagram of the hydraulic system of FIG. 7 in a second configuration.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

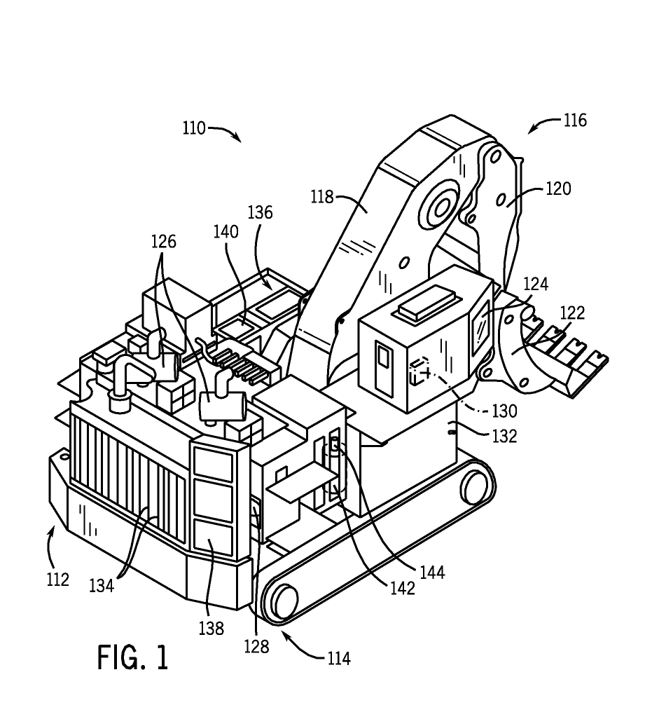

Referring to FIG. 1, heavy equipment in the form of a power shovel 110 includes a revolving deck 112 mounted on tracks 114. An articulated arm 116 having a boom 118, a stick 120, and a bucket 122 extending from the revolving deck 112. The power shovel 110 further includes an operator compartment 124 (e.g., cabin) and two diesel engines 126 that drive alternators 128 for generating electricity. A computerized controller 130 may be located in the operator compartment 124. Additional electrical components are stored in a housing 132 (e.g., e-house) below the operator compartment 124, for facilitating operation of the articulated arm 116 and other features of the power shovel 110. Fans and associated intakes 134, 136 direct cooling air to the engines 126 and other interior components of the power shovel 110.

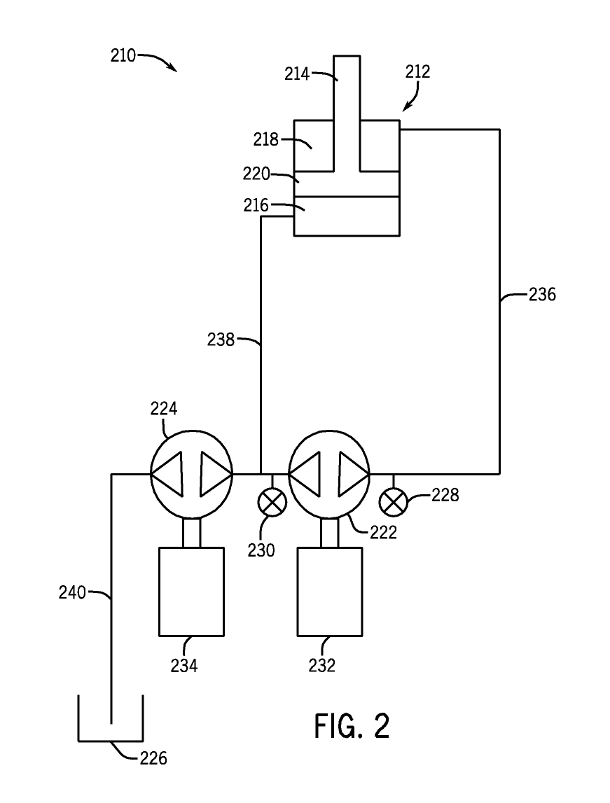

According to an exemplary embodiment, the alternators 128 supply electricity to a bus (not shown) that is coupled to twelve electric motors 142 (see also motors 234, 232 as shown in FIG. 2), which are in turn coupled to hydraulic pumps 144 (see also pumps 222, 224 as shown in FIG. 2) for pressurizing hydraulic fluid. In some embodiments, the hydraulic pumps may also be operated in reverse to drive the electric motors as alternators for regeneration of electricity. Surplus electricity on the bus may be stored in a bank of ultra-capacitors 138 (e.g., capacitor tower, stacked super-capacitors). The pressurized hydraulic fluid provided to and from the hydraulic pumps is managed by a valve manifold 140 (e.g., cartridge valve manifold) able to connect and disconnect one or more hydraulic pumps with one or more hydraulic actuators (e.g., cylinders), for operating the power shovel 110.

The power shovel 110 is designed for mining and extraction of minerals, among other uses. In some instances, the power shovel 110 may be operated according to a dig cycle that includes digging, swinging, dumping, and returning steps. According to an exemplary embodiment, the hydraulic actuators may be used facilitate the dig cycle steps by allowing the power shovel 110 to hoist the bucket 122 upward through a bank of earth, crowd the bucket 122 relative to the bank (e.g., translate in or out, to control the cut depth), swing the revolving deck 112 relative to the tracks 114, and propel the power shovel 110 by way of the tracks 114.

While the power shovel 110 of FIG. 1 may be useful as an exemplary embodiment, the teachings provided herein are not intended to be limited to power shovels. Many forms of equipment use hydraulic systems and may benefit from the teachings of the present disclosure, including industrial extruders, hydraulic test machines, trash compactors, and other forms of heavy equipment, such as mining and construction equipment (e.g., backhoe).

Referring now to FIG. 2, a hydraulic system 210 (e.g., hydraulic circuit) is designed for use with a double-acting cylinder 212 having a piston 220 fixed to a single piston rod 214, and a cap end 216 opposite to a rod end 218 through which the rod 214 translates. Controlled flow of hydraulic fluid to and from each of the ends 216, 218 both extends and retracts the rod 214. Because of the rod 214, the volume of hydraulic fluid to fill the ends 216, 281 differs, such as by a ratio of about 2:1 of the cap end to the rod end, depending upon the particular geometry of the rod and cylinder. In some embodiments, one or more such double-acting cylinders 212 may be coupled to heavy equipment, such as joints of an articulated arm (see, e.g., articulated arm 116 as shown in FIG. 1).

According to a hypothetical application, adding hydraulic fluid to the rod end 218 and correspondingly removing hydraulic fluid from the cap end 216 of the double-acting cylinder 212 positioned between a bucket and a stick, may rotate a bucket in an upward direction (see, e.g., bucket 122 and stick 120 as shown in FIG. 1). Removing the hydraulic fluid from the rod end 218 and adding the hydraulic fluid to the cap end 216, such as by pump and/or by force of gravity acting on the bucket, may rotate the bucket in the downward direction.

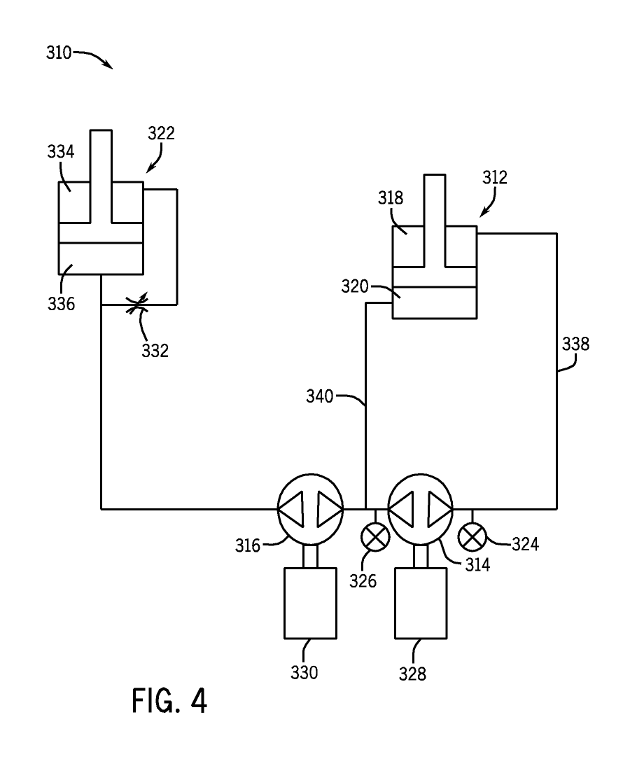

According to an exemplary embodiment, the hydraulic system 210 is configured as a semi-closed hydraulic system and further includes a first pump 222 (e.g., head-rod pump), a second pump 224 (e.g., head-tank pump), a reservoir 226 (e.g., tank), and pressure sensors 228, 230. The first and second pumps 222, 224 are associated with the rod end 218 and cap end 216 of the double-acting cylinder 212, respectively. According to such an embodiment, the first pump 222 is a bi-directional, fixed-displacement, hydraulic pump, which is functionally positioned in series with the rod end 218 and the cap end 216 of the double-acting cylinder 212, similar to a pump for a closed-loop hydraulic system. The second pump 224 is also a bi-directional, fixed-displacement, hydraulic pump, and is positioned between the cap end 216 of the double-acting cylinder 212 and the reservoir 226, similar to a pump for an open-loop hydraulic system. In other contemplated embodiments, in place of or in combination with the reservoir 226, the first pump 222 or the second pump 224 is coupled to a second cylinder (see generally second cylinder 322 as shown in FIG. 4), an accumulator, or another body or bodies for providing and/or receiving hydraulic fluid. In still other contemplated embodiments, more than two pumps may be used and/or the pumps may be variable-displacement pumps (e.g., impeller, centrifugal pumps). In some embodiments, the output or rate of a pump may be controlled by changing the speed of an associated electric motor driving the pump, by changing the displacement volume of the pump, such as by changing the angle of a swash plate driving pistons for an associated axial cam pump, or otherwise.

In some embodiments, the first and second pumps 222, 224 may be driven by reversible electric motors 232, 234. In other contemplated embodiments, the first and second pumps 222, 224 are coupled to one-way electric motors or engines, which are able to reverse themselves by way of gearing or another mechanism. In other embodiments, separate one-way motors are used for each direction of the pumps 222, 224. In any such case, the first pump 222 is configured to deliver pressurized hydraulic fluid from the cap end 216 to the rod end 218 of the double-acting cylinder 212, and also from the rod end 218 to the cap end 216 thereof. Similarly, the second pump 224 is configured to deliver pressurized hydraulic fluid from the reservoir 226 to the cap end 216 of the double-acting cylinder, and from the cap end 216 to the reservoir 226.

According to an exemplary embodiment, the first and second pumps 222, 224 are at least partially controlled as a function of signals (e.g., electronic signals, mechanical movements) provided by the pressure sensors 228, 230. A first pressure sensor 228 is configured to detect the pressure of hydraulic fluid of the rod end 218 of the double-acting cylinder 212 and/or of plumbing 236 associated with the rod end 218. In some embodiments, the first pressure sensor 228 is positioned along a portion of the plumbing 236 between the rod end 218 of the double-acting cylinder 212 and the first pump 222. In other contemplated embodiments, the first pressure sensor 228 is integrated with either the rod end 218 of the double-acting cylinder 212 or the inlet of the first pump 222 (i.e., on the rod-end side of the first pump 222).

According to an exemplary embodiment, the second pressure sensor 230 is configured to detect the pressure of hydraulic fluid of the cap end 216 of the double-acting cylinder 212 and/or of plumbing 238 associated with the cap end 216. The second pressure sensor 230 may be integrated with the cap end 216 of the double-acting cylinder 212, the inlet for the first or second pumps 222, 224 (i.e., on the cap-end sides), or the associated plumbing 238 extending between the cap end 216, the first pump 222, and the second pump 224.

In some embodiments, a controller (e.g., pressure-sensitive switch, mechanical linkage, control circuitry; see generally computerized controller 130 as shown in FIG. 1) uses output signals from the pressure sensors 228, 230 monitoring the hydraulic fluid to operate the pumps 222, 224. In some such embodiments, the pumps 222, 224 are run at speeds intended to reduce or prevent cavitations (also called voids) from forming in the hydraulic fluid, which may wear or otherwise damage the hydraulic system 210. Accordingly, when one or both of the pressure sensors 228, 230 detect that the pressure in a body of hydraulic fluid is approaching a pressure at which cavitations may form, the controller changes the speed of one or more of the pumps 222, 224 to change the pressure in the hydraulic fluid. In one hypothetical scenario, as hydraulic fluid is pumped by the first pump 222 from the rod end 218 to the cap end 216, the speed of the first pump 222 is reduced as the first pressure sensor 228 detects a pressure in the hydraulic fluid that is indicative of void-inducing conditions.

In other embodiments, other forms of sensors are used with or in place of the pressure sensors 228, 230 to detect and/or prevent cavitations from forming in the hydraulic fluid. In contemplated embodiments, strain gauges or load cells are coupled to the pumps 222, 224, the associated plumbing 236, 238, 240, or the double-acting cylinder 212, which detect displacements or loads that may be correlated to pressure in the hydraulic fluid passing through the pumps 222, 224, the associated plumbing 236, 238, 240, or the double-acting cylinder 212. In other contemplated embodiments, accelerometers are used to detect vibrations of the plumbing 236, 238, 240 caused by collapsing voids, or auditory sensors are used to detect sound associated with the collapsing voids. In some embodiments, sensors are used to detect other conditions of the hydraulic fluid, such viscosity, temperature, cleanliness, etc., allowing the controller to operate the pumps 222, 224 at least partly as a function of such conditions.

According to an exemplary embodiment, no check valves are used between the first pump 222 and the rod end 218 of the double-acting cylinder 212. In some such embodiments, flow restriction devices in addition to the pump 222 are also not used. Instead, the first pump 222 is operated by the controller to manage the pressure of hydraulic fluid in the rod end 218, as desired for an associated task of the double-acting cylinder 212. Additionally, no check valves are positioned between the first and second pumps 222, 224 and the cap end 216 of the double-acting cylinder 212. The first and second pumps 222, 224 are operated together to manage the pressure of hydraulic fluid in the cap end 216 of the double-acting cylinder 212. Absence of check valves and/or restriction devices is intended to remove sources of pressure losses in the flow of hydraulic fluid through the system 210, improving overall system efficiency with regard to energy consumption and use of resources (e.g., pumps 222, 224, motors 232, 234, electricity, etc.).

According the an exemplary embodiment, in addition to pumping fluid to and from each of the ends 216, 218 of the double-acting cylinder 212, the first pump 222 is configured to receive a pressurized flow of hydraulic fluid from either the rod end 218 or the cap end 216, and to controllably dampen (e.g., slow) the flow rate of the pressurized hydraulic fluid. The second pump 224 may be operated by the controller in conjunction with the first pump 222 to controllably dampen a pressurized flow of hydraulic fluid from the cap end 216 of the double-acting cylinder 212. Such damping by the first pump 222 and/or the second pump 224 is intended, without the use of check valves or additional flow restrictors, to prevent “breakaway” cylinder acceleration as may occur when movement of the piston rod 214 is driven by gravity.

According to an exemplary embodiment, the hydraulic system 210 includes at least four control modes. First, when the rod 214 extends under resistance, the first pump 222 controls the pressure of hydraulic fluid in the rod end 218, and the second pump 224 supplements the first pump 222 to achieve a desired flow rate. Second, when the rod 214 retracts overrunning (i.e., with gravity pushing), the first pump 222 controls the pressure in the rod end 218 and the second pump 224 controls the speed of the retraction, such as by damping the flow. Third, when the rod 214 extends overrunning, the second pump 224 controls the pressure in the cap end 216 and the first pump 222 controls the speed of extension. Fourth, when the rod 214 retracts under resistance, the second pump 224 controls the pressure in the cap end 216 and the first pump 222 controls the flow rate, such as by supplementing the flow of the second pump 224.

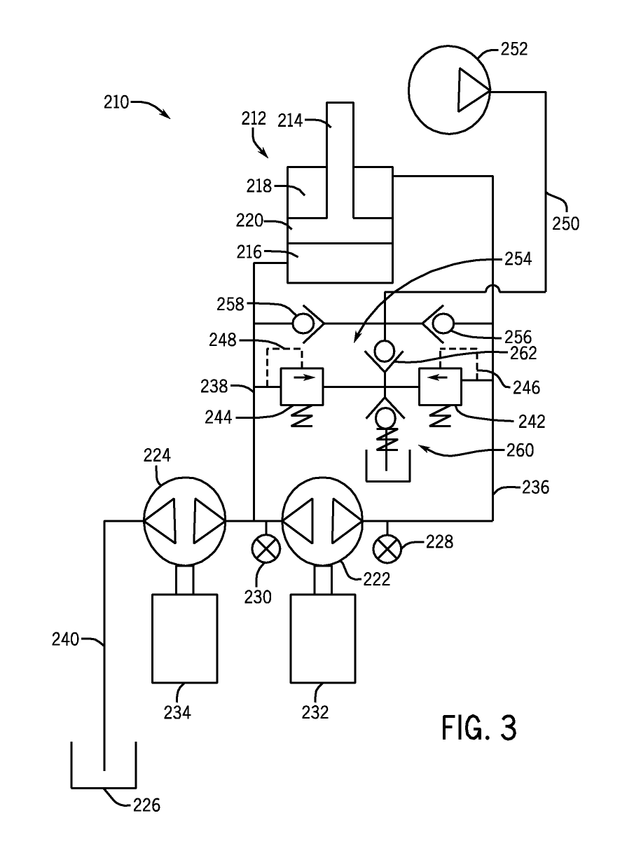

Referring to FIG. 3, the hydraulic system 210 may further include a makeup pump 252 (e.g., charge pump) and relief system 254. According to an exemplary embodiment, the makeup pump 252 is a unidirectional fixed displacement hydraulic pump, and may be coupled to the reservoir 226. Due to leaks or other reasons, the amount of hydraulic fluid in the double-acting cylinder 212 and associated plumbing 236, 238, 240 may fall below a desired level. At which time, the makeup pump 252 may be activated to add hydraulic fluid to the plumbing 236, 238 associated with either or both of the rod end 218 and cap end 216 of the double-acting cylinder 212. Check valves 256, 258 may be arranged between plumbing 250 associated with the charge pump 252 and plumbing 236, 238 associated with either or both of the rod end 218 and cap end 216 of the double-acting cylinder 212, to prevent back flowing of pressurized hydraulic fluid to the makeup pump 252. According to a preferred embodiment, the check valves 256, 258 are not blocking or limiting flow along the plumbing 236, 238 between the pumps 222, 224 and the respective ends 218, 216 of the double-acting cylinder 212.

The relief system of FIG. 3 includes first and second directional control valves 242, 244, where the first directional control valve 242 is coupled to the plumbing 236 associated with the rod end 218 of the double-acting cylinder 212, and the second directional control valve 244 is coupled to the plumbing 238 associated with the cap end 216. Pilots 246, 248 for each directional control valve 242, 244 operate the respective directional control valve 242, 244 as a function of pressures (or other conditions) of the hydraulic flow in the respective plumbing 236, 238. When relief is desired, the directional control valves 242, 244 open to allow hydraulic fluid to pass to the plumbing 250 associated with the makeup pump. If pressure in the plumbing 250 associated with the makeup pump 252 as well as the plumbing associated 236, 238 with each end 216, 218 of the double-acting cylinder 212 exceeds a desired pressure, then a back pressure check valve 260 may allow hydraulic fluid to leave the system 210, or pass to the reservoir 226. An additional check valve 262 prevents flow that has been provided by the makeup pump 252 to pass to directional control valves 242, 244 and back pressure check valve 260.

Referring to FIG. 4, a hydraulic system 310 includes a double-acting cylinder 312 (e.g., first cylinder), a first pump 314 functionally located intermediate to a rod end 318 and a cap end 320 of the double-acting cylinder 312, a second pump 316 functionally located between the cap end 320 of the double-acting cylinder 312, and a second cylinder 322. Pressure sensors 324, 326 are arranged to sense pressure of hydraulic fluid associated with each end 318, 320 of the double-acting cylinder 312. According to such an embodiment, feedback from the pressure sensors 324, 326 may be used to help control the direction and speed of reversible motors 328, 330 coupled to the pumps 314, 316, so as to prevent cavitations while quickly actuating the double-acting cylinder 312.

During operation of the hydraulic system 310, energy stored in hydraulic fluid exiting the double-acting cylinder 312 may be regenerated (e.g., reused, transferred, conserved, reapplied) by providing the hydraulic fluid to the second cylinder 322 for operation of the second cylinder 322. In essence, the double-acting cylinder 312 performs the ‘double duty’ of emptying the double-acting cylinder 312 while filling the second cylinder 322. In some such embodiments, no intermediate pump or reservoir is required. The flow path between the double-acting cylinder 312 and the second cylinder 322 may be controlled by way of the second pump 316, with or without control valves or other pumps between the second pump 316 and the second cylinder 322. Transfer of pressurized hydraulic fluid between the cylinders 312, 322 is intended to regenerate energy without losses associated with conversion of the energy to another form of energy, such as mechanically storing the hydraulic energy in a rotating flywheel, or converting the energy to electricity by way of the reversible motors 328, 330 functioning as generators. However in other contemplated embodiments, at least some excess hydraulic energy may be converted to mechanical or electrical energy, stored, and reused.

According to a hypothetical scenario, the double-acting cylinder 312 is coupled to a stick of a power shovel (see, e.g., stick 120 and power shovel 110 as shown in FIG. 1) and the second cylinder 322 is coupled to a boom (see, e.g., boom 118 as shown in FIG. 1) of the power shovel. During a maneuver where the stick is raised and the boom is lowered, the hydraulic fluid from the cap end 320 of the double-acting cylinder 312 may be transferred both to the rod end 318 of the double-acting cylinder 312 by way of the first pump 314 and to the second cylinder 322 by way of the second pump 316. If the maneuver is overrunning, gravity may assist by pushing the hydraulic fluid to the rod end 318 and the second cylinder 322, regenerating the potential energy that was stored in the hydraulic fluid of the cap end 320 of the double-acting cylinder 312 prior to the maneuver.

According to an exemplary embodiment, the second cylinder 322 includes a flow restrictor 332 (e.g., electronic proportional control valve) positioned between ends 334, 336 of the second cylinder 322. Via the flow restrictor 332, the rod end 334 of the second cylinder 322 is restricted, mitigating the danger of breakaway cylinder acceleration. The flow restrictor 332 may be a variable flow restrictor such as a bi-directional pump or a valve having an adjustable through path (e.g., ball valve), or another form of restrictor. In addition, although schematically represented in FIG. 4 as a hydraulic cylinder similar to the double-acting cylinder 312, the second cylinder 322 may be any of a broad range of hydraulic cylinders (e.g., telescopic cylinders, welded-body style cylinders, etc.), linear actuators, accumulators, hydraulic tanks, and the like, that are configured to provide and/or receive hydraulic fluid.

According to an exemplary embodiment, plumbing 338 between the first pump 314 and the rod end 318 of the double-acting cylinder 312 includes no check valves. Further, plumbing 340 between the first pump 314, the second pump 316, and the cap end 320 of the double-acting cylinder 312 includes no check valves. Instead the first and second pumps 314, 316 are controlled to manage the pressure of hydraulic fluid in the ends 318, 320 of the double-acting cylinder 312 by selectively reversing the direction and changing speeds of the first and second motors 330, 328.

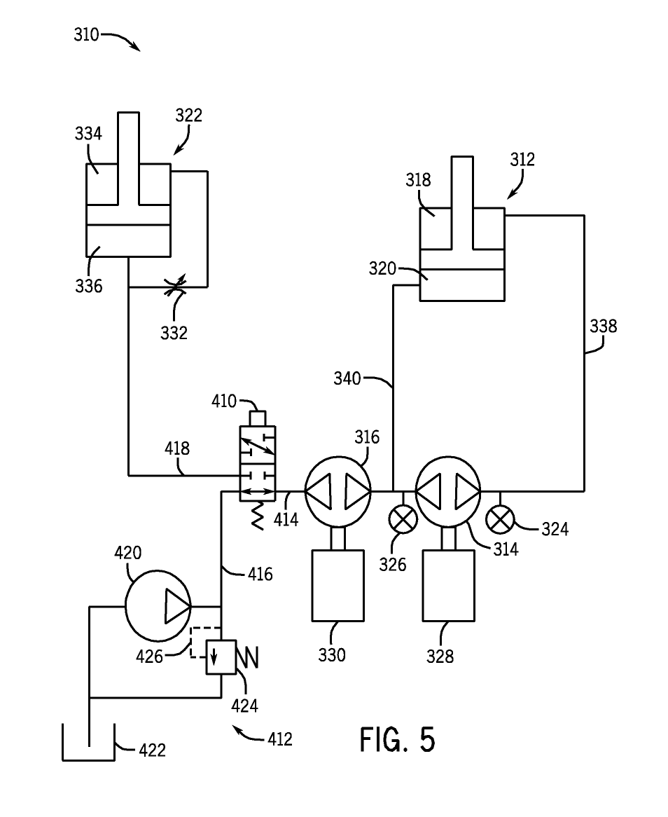

Referring to FIG. 5, the hydraulic system of FIG. 4 may further include a directional control valve 410 and charge system 412 functionally located intermediate to the second pump 316 and the second cylinder 322. According to an exemplary embodiment, the directional control valve 410 has four ports and two finite positions, such that either plumbing 414 associated with second pump 316 is coupled to plumbing 416 of the charge system 412, or the plumbing 414 is coupled to plumbing 418 of the second cylinder 322. Operation of the valve 410 may be controlled as a function of the amount of hydraulic fluid present in double-acting cylinder 312 and associated plumbing 338, 340, and also as a function of whether the system 310 is undergoing a maneuver involving energy regeneration. As shown, the valve 410 is biased to connect the plumbing 414 of the second pump 316 with the charge system 412.

According to an exemplary embodiment, the charging system 412 includes a charge pump 420 (e.g., one-way, fixed-displacement, hydraulic pump; variable-displacement pump) coupled to a reservoir 422 of hydraulic fluid. If the amount of hydraulic fluid in the hydraulic system 310 drops below a desired threshold, the charge pump 420 may be controlled to add hydraulic fluid to the hydraulic system 310. The charging system 412 further includes a directional control valve 424 (e.g., on/off valve) functionally positioned in parallel with the charge pump 420. The directional control valve 424 selectively allows hydraulic fluid to pass to the reservoir 422, such as when the amount of hydraulic fluid in the hydraulic system 310 is greater than a desired threshold. In some embodiments, the directional control valve 424 is operated by way of a pilot 426 that is sensitive to pressure of hydraulic fluid in the plumbing 416 of the charging system 412 coupled to the directional control valve 410 (e.g., opening when the pressure reaches 15 bar).

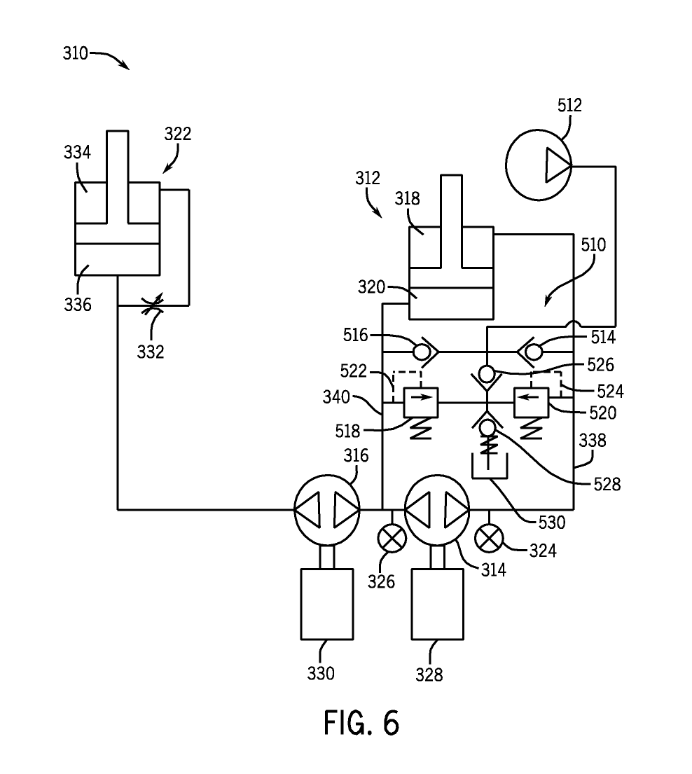

Referring to FIG. 6, the hydraulic system 310 of FIG. 4 may alternatively include a relief system 510 similar to that described with respect to the hydraulic system 210 shown in FIG. 3. A makeup pump 512 may be selectively activated to add hydraulic fluid to the plumbing 338, 340 associated with either or both of the rod end 318 and the cap end 320 of the double-acting cylinder 312. Check valves 514, 516 prevent back flow to the makeup pump 512.

Additional one-way directional control valves 518, 520, respectively coupled to the plumbing 338, 340 of the rod end 318 and cap end 320 of the double acting cylinder 312, use pilots 522, 524 to selectively open and relieve excess pressure in the pumps 314, 316 and ends 318, 320 of the double-acting cylinder 312. Excess hydraulic fluid is delivered from one end 318, 320 to the other end 318, 320 of the double-acting cylinder 312, past a check valve 526 and the respective check valve 514, 516, or out of the hydraulic system 310 by way of a back-pressure relief check valve 528, which may lead to a reservoir 530 (see also reservoir 422 as shown in FIG. 5) coupled to the makeup pump 512. In contemplated embodiments, a hydraulic system may include features of both the charging system of FIG. 5 and the relief system of FIG. 6.

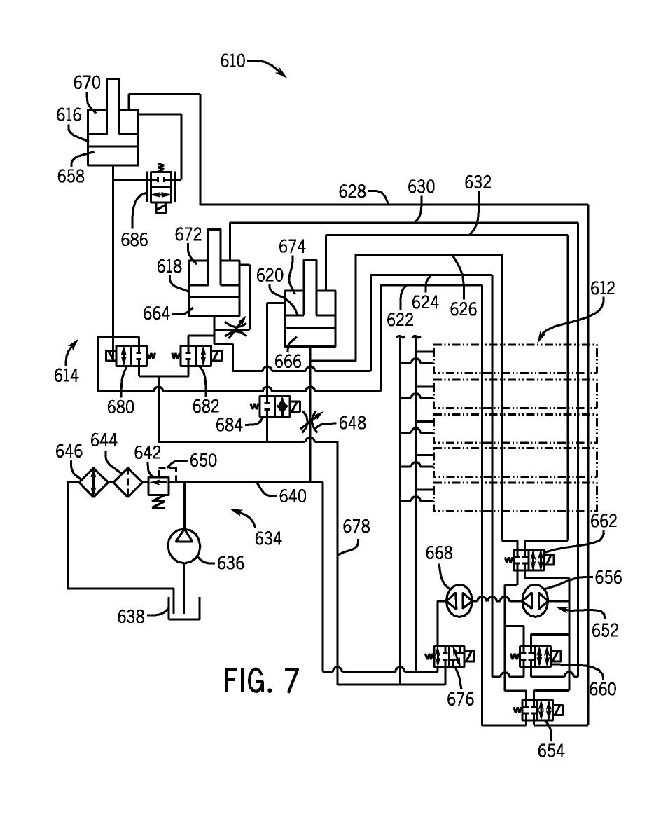

Referring to FIGS. 7-9, a hydraulic system 610 includes an array of pump pairs 612 (e.g., six pairs) that may be selectively coupled to a plurality of actuators 614 (e.g., linear actuators, hydraulic motors, etc.). By way of non-limiting example, the plurality of actuators 614 may include a first double-acting cylinder 616 for controlling a boom, a second double-acting cylinder 618 for controlling a stick, and a third double-acting cylinder 620 for controlling a bucket (see, e.g., boom 118, stick 120, and bucket 122 of power shovel 110 as shown in FIG. 1). Common rails 622, 624, 626, 628, 630, 632 (e.g., plumbing, pipes, conduits) may be used by more than one pump of the array of pump pairs 612 to supply hydraulic fluid to and/or receive hydraulic fluid from the double-acting cylinders 614, 616, 618. Additionally, the hydraulic system 610 includes a charge, filtration, and makeup system 634. Sensors (see, e.g., pressure sensors 228, 230 as shown in FIG. 2) may be coupled to the common rails 622, 624, 626, 628, 630, 632, to any or all of the pumps of the array of pump pairs 612, and/or to any or all of the actuators of the plurality of actuators 614.

The charge, filtration, and makeup system 634 includes a pump 636 (e.g., charge pump, makeup pump, filtration pump; e.g., providing fluid at 5000 liters per minute) configured to supply hydraulic fluid from a reservoir 638 to a rail 640 that may be selectively coupled to other rails 622, 624, 626, 628, 630, 632 of the hydraulic system 610. Further the charge, filtration, and makeup system 634 includes a directional control valve 642 selectively allowing hydraulic fluid to return to the reservoir 638. In some such embodiments, the valve 642 may be controlled by a pilot 650 and set to open at pressures of 15 bar. The charge, filtration, and makeup system 634 may further include a filter 644 for removing contaminants from the hydraulic fluid and a cooler 646 for lowering the temperature of the hydraulic fluid. A variable restrictor 648 (e.g., electronic proportional control valve) may be used to control the flow of hydraulic fluid to other rails (e.g., rail 626) of the hydraulic system 610 for charging or makeup purposes.

According to an exemplary embodiment, a first pump pair 652 of the array of pump pairs 612 includes a first directional-control valve 654 (e.g., normally-closed directional-control valve with four ports and two finite positions, those positions being open or closed; on/off valve) for selectively coupling a second pump 656 of the first pump pair 652 to a cap end 658 of the double-acting cylinder 616 controlling the boom. Second and third directional-control valves 660, 662 selectively couple the second pump 656 to cap ends 664, 666 of the double-acting cylinders 618, 620 controlling the stick and bucket, respectively. In such an embodiment, the directional control valves 654, 660, 662 are on/off valves to connect the second pump 656 to one or more of the rails 622, 624, 626 connected to the cap ends 658, 664, 666 of the double-acting cylinders 616, 618, 620; and when open, the valves 654, 660, 662 provide little to no additional resistance to the flow.

According to an exemplary embodiment, a first pump 668 in the first pump pair 652 is coupled to another set of directional-control valves (not shown) similar to the directional-control valves 654, 660, 662 coupled to the second pump 656 of the first pump pair 652. By way of the directional-control valves, the first pump 668 may be selectively coupled to rod ends 670, 672, 674 of the first, second, and third double acting cylinders 616, 618, 620, and/or to the cap ends 658, 664, 666 of the first, second, and third double-acting cylinders 616, 618, 620 by way of the rails 622, 624, 626, 628, 630, 632.

As such, the first pump 668 may selectively deliver pressurized hydraulic fluid from any of the rod ends 670, 672, 674 of the double-acting cylinders 616, 618, 620 to any of the cap ends 658, 664, 666 of the double-acting cylinders 616, 618, 620. In some embodiments, the first 668 pump may also be coupled to the charge, filtration, and makeup system 634. The second pump of the first pump pair is functionally located between the cap ends 658, 664, 666 of the double-acting cylinders 616, 618, 620 and the reservoir 638 of the charge, filtration, and makeup system 634, and may deliver pressurized hydraulic fluid to any of the cap ends 658, 664, 666 of the double-acting cylinders 616, 618, 620 from the reservoir 634, or to the reservoir 634 from any of the cap ends 658, 664, 666 of the double-acting cylinders 616, 618, 620.

According to an exemplary embodiment, each pump of the array of pump pairs 612 is coupled to a set of directional control valves similar to the directional-control valves 654, 660, 662 coupled to the second pump 656 of the first pump pair 652. As such, any pump pair may be used to actuate any of the first, second, and third double-acting cylinders 616, 618, 620. Furthermore, combinations of pump pairs may be used to amplify the amount of hydraulic energy provided to any of the first, second, and third double-acting cylinders 616, 618, 620. In some embodiments, the directional control valves (e.g., valves 654, 660, 662) associated with each pump (e.g., pumps 656, 668) of the array of pump pairs 612 are housed in a single manifold (see, e.g., hydraulic manifold 140 as shown in FIG. 1) operated by a controller (see, e.g., computerized controller 130 as shown in FIG. 1). In other embodiments, one or more pumps of the array of pump pairs 612 may be selectively coupled to less than all of the double-acting cylinders, some cap end and some rod ends of different double-acting cylinders, or to hydraulic actuators that are not cylinders.

Furthermore, as shown in FIGS. 7-9, another directional control valve 676 (e.g., normally open directional control valve with four ports and two finite positions) selectively couples the first pump 668 to both a regeneration rail 678 and the rail 640 of the charge, filtration, and makeup system 634. The regeneration rail 678 may be used when the energy stored in hydraulic fluid is to be delivered from one end of one of the double-acting cylinders 616, 618, 620 to another end of one of the double-acting cylinders 616, 618, 620, such as when one cylinder is retracting while another is expanding. Additional directional control valves 680, 682, 684 (e.g., normally closed directional control valves having two ports and two finite positions) open or close the regeneration rail 678 with respect to each of the double-acting cylinders 616, 618, 620, with the directional control valve 684 for the double-acting cylinder 620 of the bucket including check valve position.

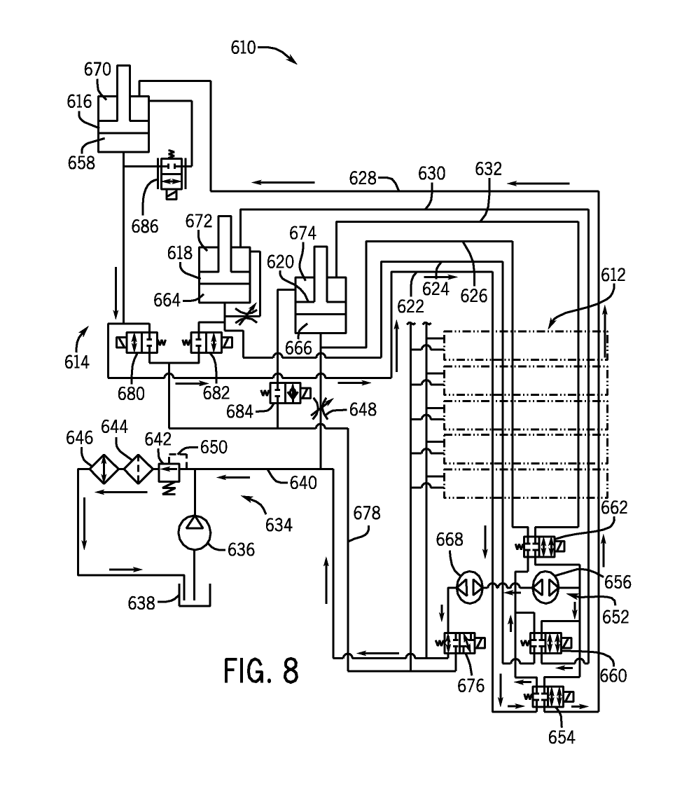

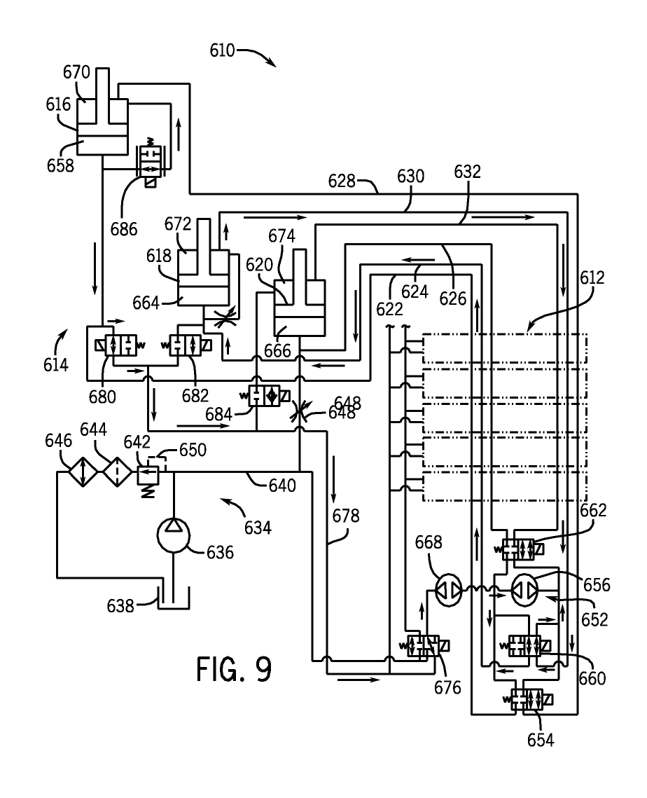

Referring to FIGS. 7-9, during a first exemplary operation (FIG. 8) of the hydraulic system 610 the double-acting cylinder 616 of the boom retracts. Hydraulic fluid is directed from the cap end 658 to the first pump pair 652, and by way of the first pump pair 652 to the rod end 670 and to the reservoir 638. Accordingly, hydraulic fluid is regenerated from the cap end 658 to the rod end 670 of the double-acting cylinder 616 of the boom. During a second exemplary operation (FIG. 9), the double-acting cylinder 616 of the boom retracts (similar to the first operation of FIG. 8) and the double-acting cylinder 618 of the stick extends. Hydraulic fluid is directed from the cap end 658 of the double-acting cylinder 616 of the boom to the cap end 664 of the double-acting cylinder 618 of the stick by way of the regeneration rail 678 and the first pump pair 652. Additional hydraulic fluid is directed from the rod end 672 of the double-acting cylinder 618 of the stick to the cap end 664 of the double-acting cylinder 618 of the stick by way of the first pump pair 652. The rod end 670 of the double-acting cylinder 616 of the boom may be supplied by hydraulic fluid from the cap end 658 by way of a control valve 686 having infinite variability, rather than on/off. In contemplated embodiments, valves similar to the control valve 686 may be used with or in place of electronic proportional control valves (e.g., restrictor 648), and vice versa.

The construction and arrangements of the hydraulic system, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A semi-closed hydraulic system for use with heavy equipment, comprising:
a double-acting cylinder having a rod end and a cap end;
a reservoir configured to provide hydraulic fluid to and receive hydraulic fluid from the cap end of the double-acting cylinder;
a first electric motor;
a first pump coupled to the first electric motor and configured to be driven thereby, wherein the first pump is intermediate to the rod end and the cap end of the double-acting cylinder, wherein the first pump is bi-directional and configured to provide hydraulic fluid to the rod end from the cap end, and to also provide hydraulic fluid to the cap end from the rod end;
a second electric motor;
a second pump coupled to the second electric motor and configured to be driven thereby, wherein the second pump is intermediate to the cap end of the double-acting cylinder and the reservoir, wherein the second pump is bi-directional and configured to provide hydraulic fluid to the cap end from the reservoir, and to also provide hydraulic fluid to the reservoir from the cap end;
a pressure sensor providing an output signal related to the pressure of hydraulic fluid of the rod end of the double-acting cylinder, and
a controller coupled to the pressure sensor, wherein the controller operates the first pump at least partially as a function of the output signal provided by the pressure sensor during operation of the semi-closed hydraulic system.

2. The semi-closed hydraulic system of claim 1, wherein the controller uses the first electric motor to operate the first pump as a damper between the rod end and the cap end of the double-acting cylinder.

3. The semi-closed hydraulic system of claim 2, wherein the semi-closed hydraulic system uses no check valves intermediate to the rod end of the double-acting cylinder and the first pump.

4. The semi-closed hydraulic system of claim 3, wherein the semi-closed hydraulic system uses no check valves intermediate to the cap end of the double-acting cylinder and either the first pump or the second pump.

5. The semi-closed hydraulic system of claim 4, wherein the double-acting cylinder is a first cylinder, and the semi-closed hydraulic system further comprises:
a second cylinder coupled to the first cylinder, wherein hydraulic fluid may be selectively communicated between the first and second cylinders for purely-hydraulic regeneration of energy therebetween.

6. The semi-closed hydraulic system of claim 4, wherein the pressure sensor is a first pressure sensor, and further comprising:
a second pressure sensor in communication with hydraulic fluid of the cap end of the double-acting cylinder.

7. The semi-closed hydraulic system of claim 6, wherein the controller operates the second pump at least partially as a function of the pressure sensed by the second pressure sensor during operation of the semi-closed hydraulic system.

8. The semi-closed hydraulic system of claim 7, wherein the first pump is additionally controlled at least partially as a function of the pressure sensed by the second pressure sensor during operation of the semi-closed hydraulic system.

9. A hydraulic system, comprising:
a double-acting cylinder having a rod end and a cap end;
a reservoir configured to provide hydraulic fluid to and receive hydraulic fluid from the cap end of the double-acting cylinder;
a first pump coupled intermediate to the rod end and the cap end of the double-acting cylinder, wherein the first pump is bi-directional and configured to provide hydraulic fluid to the rod end from the cap end of the double-acting cylinder, and to also provide hydraulic fluid to the cap end from the rod end of the double-acting cylinder;
a second pump coupled intermediate to the cap end of the double-acting cylinder and the reservoir, wherein the second pump is bi-directional and configured to provide hydraulic fluid to the cap end of the double-acting cylinder from the reservoir, and to also provide hydraulic fluid to the reservoir from the cap end of the double-acting cylinder;
a first pressure sensor in communication with hydraulic fluid of the rod end of the double-acting cylinder, wherein the first pump is controlled at least partially as a function of an output signal provided by the first pressure sensor during operation of the hydraulic system; and
a second pressure sensor in communication with hydraulic fluid of the cap end of the double-acting cylinder, wherein the second pump is controlled at least partially as a function of an output signal provided by the second pressure sensor during operation of the hydraulic system.

10. The hydraulic system of claim 9, wherein the first pump is additionally controlled at least partially as a function of the output signal provided by the second pressure sensor during operation of the hydraulic system.

11. The hydraulic system of claim 10, wherein the first and second pumps are driven by one or more electric motors.

12. The hydraulic system of claim 11, wherein the first and second electric motors generate electricity when at least one of the first and second pumps provide hydraulic fluid to a lower-pressure receiver from a higher-pressure source.

13. The hydraulic system of claim 11, wherein the hydraulic system uses no check valves intermediate to the rod end of the double-acting cylinder and the first pump.

14. The hydraulic system of claim 13, wherein the hydraulic system uses no check valves intermediate to the cap end of the double-acting cylinder and either the first pump or the second pump.

15. A hydraulic system, comprising:
a double-acting cylinder having a rod end and a cap end;
a first electric motor;
a first pump coupled to the first electric motor and configured to be driven thereby, wherein the first pump is intermediate to the rod end of the double-acting cylinder and the cap end of the double-acting cylinder, wherein the first pump is bi-directional and configured to provide hydraulic fluid to the rod end of the double-acting cylinder from the cap end of the double-acting cylinder, and to also provide hydraulic fluid to the cap end of the double-acting cylinder from the rod end of the double-acting cylinder;
a second cylinder;
a second electric motor;
a second pump coupled to the second electric motor and configured to be driven thereby, wherein the second pump is intermediate to the cap end of the double-acting cylinder and the second cylinder, wherein the second pump is bi-directional and configured to provide hydraulic fluid to the cap end of the double-acting cylinder from the second cylinder, and to also provide hydraulic fluid to the second cylinder from the cap end of the double-acting cylinder, whereby energy is regenerated between the double-acting cylinder and the second cylinder.

16. The hydraulic system of claim 15, wherein the hydraulic system uses no check valves intermediate to the rod end of the double-acting cylinder and the first pump.

17. The hydraulic system of claim 16, wherein the hydraulic system uses no check valves intermediate to the cap end of the double-acting cylinder and either the first pump or the second pump.

18. The hydraulic system of claim 17, wherein at least one of the first and second electric motors generate electricity when at least one of the first and second pumps provide hydraulic fluid to a lower-pressure receiver from a higher-pressure source.

19. The hydraulic system of claim 17, further comprising:
a first pressure sensor in communication with hydraulic fluid of the rod end of the double-acting cylinder, wherein the first pump is controlled at least partially as a function of an output signal provided by the first pressure sensor during operation of the hydraulic system; and
a second pressure sensor in communication with hydraulic fluid of the cap end of the double-acting cylinder, wherein the second pump is controlled at least partially as a function of an output signal provided by the second pressure sensor during operation of the hydraulic system.

20. The hydraulic system of claim 19, wherein the first pump is additionally controlled at least partially as a function of the output signal provided by the second pressure sensor during operation of the hydraulic system.
